(19) United States
(12) Patent Application Publication
(10) Pub. No.: US 2026/0155063 A1
(43) Pub. Date: Jun. 4, 2026

(54) MAGNETIC HEART VALVE FOR CARDIOVASCULAR SIMULATOR BASED ON MAGNETIC FIELD OPERATION AND MANUFACTURING METHOD THEREOF, AND SOFT MAGNETICALLY REGULATED HEART VALVE APPARATUS USING THE SAME

(71) Applicant: UNIVERSITY-INDUSTRY COOPERATION GROUP OF KYUNG HEE UNIVERSITY, Yongin-si (KR)

(72) Inventors: Yoonseok PARK, Suwon-si (KR); Gooyoon CHUNG, Seongnam-si (KR); Jeongmin YOO, Suwon-si (KR)

(21) Appl. No.: 19/358,721

(22) Filed: Oct. 15, 2025

(30) Foreign Application Priority Data
Oct. 15, 2024 (KR) 10-2024-0140711

(51) Int. Cl. G09B 23/32

(52) U.S. Cl. CPC G09B 23/32

(57) ABSTRACT

A magnetic heart valve for a cardiovascular simulator based on magnetic field operation and a manufacturing method thereof, and a soft magnetically regulated heart valve apparatus using the same is disclosed. This magnetic heart valve includes magnetic particles, and an elastic silicone composite material, it has a circular plate shape, at least one heart valve shape is formed within the circular plate shape, and at least one heart valve shape is apart from each other to allow the circular plate shape to freely bend upward or downward.

### CROSS-REFERENCE TO RELATED APPLICATION

This application claims priority to and the benefit of Korean Patent Application No. 10-2024-0140711 filed with the Korean Intellectual Property Office on Oct. 15, 2024, the entire contents of which are incorporated herein by reference.

### BACKGROUND OF THE DISCLOSURE

### (a) Field of the Disclosure

The present disclosure relates to a magnetic heart valve for a cardiovascular simulator based on magnetic field operation and a manufacturing method thereof, and a soft magnetically regulated heart valve apparatus using the same.

### (b) Description of the Related Art

The risk of invasive measurements and sample collection bias in clinical studies of cardiovascular disease emphasizes the need for accurate vascular simulators to replicate blood pressure changes.

Artificial valves, a key component of these vascular simulators, regulate blood flow and have applications in a variety of fields, including semiconductors, fluid circuit design, microfluidic control, and soft pneumatic actuators (SPAs).

The aforementioned valves regulate pressure and flow in artificial heart systems by using a variety of actuation mechanisms, including thermal, mechanical, pneumatic, magnetic, and biomimetic approaches. Among these mechanisms, magnetic actuation allows for rapid responsiveness and precise control by adjusting the strength and direction of the magnetic field, while bio-inspired structures provide superior efficiency and structural stability.

On the other hand, the magnetically actuated valve can be manipulated by an external magnetic field by incorporating a permanent magnet or a silicone elastomer containing magnetic particles. However, these materials require additional permanent magnets and have difficulties in smooth fluid control.

Recently, precise flow control technology using a proportional-integral-differential (PID) controller with an electromagnet and a compensation circuit has been developed. Additionally, research inspired by the movement of insects has produced foldable magnetic silicone membranes, leading to the creation of a soft valve utilizing two of these membranes.

However, the aforementioned PID control system often fails to operate stably due to lack of fast response, and the insect-inspired soft valve faces spatial constraints due to the relatively large external magnetic system.

Therefore, a technology capable of rapidly responding to changes in the magnetic field to precisely adjust fluid pressure and flow rate, and through this, generating various pressure waveforms and accurately replicating various blood pressure changes in a compact design is required.

### SUMMARY OF THE DISCLOSURE

The present disclosure attempts to provide a magnetic heart valve for a cardiovascular simulator based on magnetic field operation and a manufacturing method thereof, and a soft magnetically regulated heart valve apparatus using the same, capable of rapidly respond to changes in the magnetic field to precisely adjust blood pressure and flow rate.

In order to achieve the object of the present disclosure as described above and to realize the characteristic effect of the present disclosure described later, the characteristic configuration of the present disclosure is as follows.

A magnetic heart valve may include magnetic particles, and an elastic silicone composite material, where the magnetic heart valve has a circular plate shape, at least one heart valve shape is formed within the circular plate shape, and the at least one heart valve shape is apart from each other to allow the circular plate shape to freely bend upward or downward.

The at least one heart valve shape may include three flaps forming a Y shape based on a center of the circular plate shape.

The magnetic particles may be neodymium-iron-boron (NdFeB) micro particles, and the elastic silicone composite material may be Ecoflex.

The three flaps can be magnetized in a direction toward a center of the magnetic heart valve or magnetized in a direction away from the center of the magnetic heart valve.

When the three flaps may be magnetized in the direction toward the center of the magnetic heart valve, an operation of bending in a direction of an external magnetic field applied perpendicularly to the magnetic heart valve is performed.

When the three flaps are magnetized in the direction away from the center of the magnetic heart valve, an operation of bending in a direction opposite to a direction of an external magnetic field applied perpendicularly to the magnetic heart valve may be performed.

A manufacturing method of a magnetic heart valve may include generating a mixture by mixing magnetic particles and an elastic silicone composite material, curing the mixture, forming at least one heart valve shape with respect to the cured mixture, and generating a final magnetic heart valve by cutting a circular plate shape from the cured mixture, where the at least one heart valve shape is apart from each other so that bending upward or downward of the circular plate shape is freely achieved.

The at least one heart valve shape may include three flaps forming a Y shape based on a center of the circular plate shape, the manufacturing method of the magnetic heart valve may further include magnetizing each of the three flaps in a direction toward a center of the magnetic heart valve, and the three flaps may perform an operation of bending in a direction of an external magnetic field applied perpendicularly to the magnetic heart valve.

The at least one heart valve shape may include three flaps forming a Y shape based on a center of the circular plate shape, the manufacturing method of the magnetic heart valve may further include magnetizing each of the three flaps in a direction away from a center of the magnetic heart valve, and the three flaps may perform an operation of bending in a direction opposite to a direction of an external magnetic field applied perpendicularly to the magnetic heart valve.

A soft magnetically regulated heart valve apparatus may include an upper magnetic heart valve system formed by joining two magnetic heart valves, a lower magnetic heart valve system formed by joining two magnetic heart valves, an electromagnet having an upper end surface joined to the upper magnetic heart valve system, and a lower end surface joined to the lower magnetic heart valve system, and a polylactic acid (PLA) housing joined to side surfaces of the upper magnetic heart valve system, the lower magnetic heart valve system and the electromagnet, so as to surround the upper magnetic heart valve system, the lower magnetic heart valve system and the electromagnet, where the magnetic heart valve may include magnetic particles, and an elastic silicone composite material, the magnetic heart valve has a circular plate shape, at least one heart valve shape is formed within the circular plate shape, and the at least one heart valve shape is apart from each other to allow the circular plate shape to freely bend upward or downward.

The two magnetic heart valves of the upper magnetic heart valve system may be joined to each other by using two first polyimide tapes inserted therebetween, and the two magnetic heart valves of the lower magnetic heart valve system may be joined to each other by using two second polyimide tapes inserted therebetween.

Each of the two first polyimide tapes and the two second polyimide tapes has a second circular plate shape that is the same as the magnetic heart valve, the at least one heart valve shape forming a Y shape based on a center of the second circular plate shape is formed within the second circular plate shape, and the at least one heart valve shape is apart from each other to allow the second circular plate shape to freely bend upward or downward.

The at least one heart valve shape may include three flaps forming a Y shape based on a center of the circular plate shape, the three flaps of two magnetic heart valves each of the upper magnetic heart valve system may be magnetized in directions opposite to each other, and the three flaps of two magnetic heart valves each of the lower magnetic heart valve system may be magnetized in directions opposite to each other.

The electromagnet may provide an external magnetic field configured to control flow of fluid through the upper magnetic heart valve system and the lower magnetic heart valve system by operating at least one heart valve shape of the upper magnetic heart valve system and the lower magnetic heart valve system.

The electromagnet may sequentially or gradually change an external magnetic field so that the upper magnetic heart valve system and the lower magnetic heart valve system may sequentially or gradually operate from a closed state to an open state.

The electromagnet may apply the magnetic field is applied in a direction perpendicular to each of the upper magnetic heart valve system and the lower magnetic heart valve system in order to adjust closing and opening of at least one heart valve shape of each of the upper magnetic heart valve system and the lower magnetic heart valve system.

According to the present disclosure, various bio-signals can be reproduced and utilized in medical research and clinical trials, thereby contributing to the development of medical technology.

In addition, the rapid response speed using magnetic fields allows for instant on/off changes of the valve, which can provide great advantages in industries that require rapid changes of pressure or flow rate.

In addition, the production cost can be significantly reduced by using inexpensive magnetic materials and easy manufacturing methods.

In addition, the flow rate can be controlled by magnetic field and the compact design allows modularization, which can significantly reduce labor costs for adding and removing valves.

### BRIEF DESCRIPTION OF THE DRAWINGS

FIG. 1 is a schematic flowchart of a manufacturing method of a magnetic heart valve according to an embodiment.

FIG. 2 is a drawing schematically illustrating a manufacturing process of a magnetic heart valve according to an embodiment.

FIG. 3 is a drawing illustrating an exemplary shape of a magnetic heart valve according to an embodiment.

FIG. 4 is a schematic diagram of a soft magnetically regulated heart valve apparatus according to an embodiment.

FIG. 5A and FIG. 5B are drawings explaining an operation principle of a magnetic heart valve system according to an embodiment.

FIG. 6 is a drawing illustrating an operation example of a magnetic heart valve system according to an embodiment.

FIG. 7 is a drawing illustrating an operation example of a soft magnetically regulated heart valve apparatus according to an embodiment.

FIG. 8A, FIG. 8B and FIG. 8C are drawings illustrating an actual operation example of a soft magnetically regulated heart valve apparatus according to an embodiment.

FIG. 9 is a drawing representing a flow rate and pressure difference change according to time of a soft magnetically regulated heart valve apparatus according to an embodiment.

FIG. 10A, FIG. 10B and FIG. 10C are drawings illustrating an outlet pressure change according to time of a soft magnetically regulated heart valve apparatus according to an embodiment and temporal response.

FIG. 11 is a drawing illustrating a simulated blood pressure waveform in various parts of a human body of a soft magnetically regulated heart valve apparatus according to an embodiment.

### DETAILED DESCRIPTION OF THE EMBODIMENTS

The present disclosure will be described more fully hereinafter with reference to the accompanying drawings, in which embodiments of the disclosure are shown. As those skilled in the art would realize, the described embodiments may be modified in various different ways, all without departing from the spirit or scope of the present disclosure. Accordingly, the drawings and description are to be regarded as illustrative in nature and not restrictive. Like reference numerals designate like elements throughout the specification.

Unless explicitly described to the contrary, the word “comprise”, and variations such as “comprises” or “comprising”, will be understood to imply the inclusion of stated elements but not the exclusion of any other elements. In addition, the terms “-er,” “-or,” and “module” described in the specification mean units for processing at least one function and operation, and can be implemented by hardware components or software components and combinations thereof.

An apparatus, a device, and a server described in the present disclosure are composed of hardware including at least one processor, memory, communication apparatus, etc., and a program executed in combination with hardware is stored in a designated location. The hardware has a configuration and performance to implement a method of the present disclosure. The program includes instructions that implement the method of operation of the present disclosure described with reference to the drawings, and executes the present disclosure in combination with hardware such as a processor and a memory.

Hereinafter, a manufacturing method of a magnetic heart valve (MHV) according to an embodiment will be described.

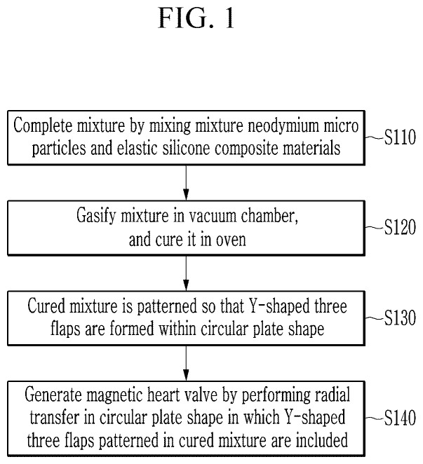

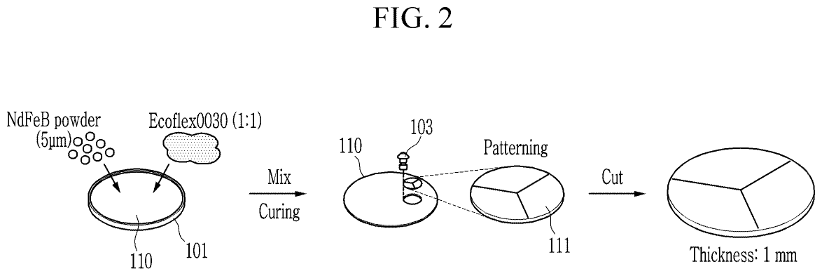

FIG. 1 is a schematic flowchart of a manufacturing method of a magnetic heart valve according to an embodiment. FIG. 2 is a drawing schematically illustrating a manufacturing process of a magnetic heart valve according to an embodiment.

Referring to FIG. 1 and FIG. 2, first, by mixing neodymium micro particles, which are magnetic particles, and an elastic silicone composite material, a mixture 110 is completed, at step S110. Specifically, the elastic silicone composite material, for example, Ecoflex (e.g., Ecoflex00-30) portions A and B, which are low-viscosity and low-hardness silicone, are mixed in a petri dish 101 prepared in advance in the ratio of 1:1 ratio, and NdFeB (90 wt %), which is magnetic micro particles, is added thereto, thereby completing the mixture 110.

Thereafter, the mixture 110 is gasifies in a vacuum chamber, and then cured, at step S120. For example, the mixture 110 may be gasified for, for example, 20 minutes, and then cured in an oven at, for example, 60 degrees Celsius for 2 hours.

Subsequently, so that Y-shaped three flaps 111 may be formed within a circular shape having a diameter of a certain diameter, for example, 20 mm, the cured mixture 110 within the petri dish 101 is patterned by using an optical fiber laser marker 103, at step S130.

Thereafter, by performing a radial cut of the cured mixture 110 into a circular shape having a diameter of 20 mm in which the Y-shaped three flaps 111 patterned in the step S130 are included, a final magnetic heart valve 120 is generated, at step S140.

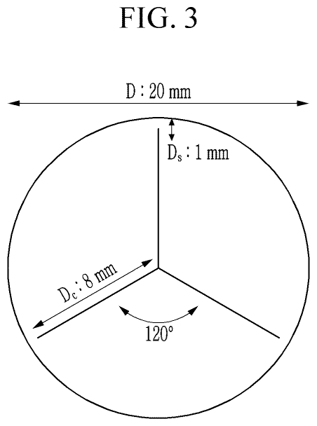

The magnetic heart valve 120 generated as such has, for example, as shown in FIG. 3, a diameter D of 20 mm, and each of the Y-shaped three flaps 111 has their end portions spaced apart from their circumferences by 1 mm interval Ds, and is set to have an angle of 120°, and an outward radial distance Dc of 8 mm.

Subsequently, a soft magnetically regulated heart valve (SMV) apparatus using a magnetic heart valve according to an embodiment will be described.

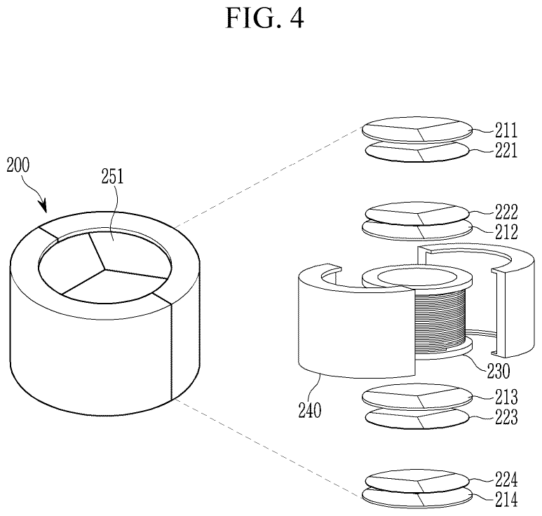

FIG. 4 is a schematic diagram of a soft magnetically regulated heart valve apparatus according to an embodiment.

As shown in FIG. 4, a soft magnetically regulated heart valve apparatus 200 according to an embodiment includes four magnetic heart valves 211, 212, 213, and 214, four polyimide tapes 221, 222, 223, and 224, an electromagnet 230 and a polylactic acid (PLA) housing 240.

The four magnetic heart valves 211, 212, 213, and 214 are magnetized so that Y-shaped three flaps 111 may be opened or closed by an external magnetic field, so that the flow of fluid can be controlled through the three flaps 111 of each of the magnetic heart valves 211, 212, 213, and 214.

The magnetic heart valves 211, 212, 213, and 214 are operated to be opened in the same direction as the external magnetic field when the three flaps 111 are magnetized toward respective centers, but to be opened in the opposite direction of the external magnetic field when the three flaps 111 are magnetized in directions away from respective centers.

The four magnetic heart valves 211, 212, 213, and 214 described above are grouped into two pairs, to form an upper magnetic heart valve system 251 and a lower magnetic heart valve system 252, respectively. Specifically, a pair of magnetic heart valves 211 and 212 form the upper magnetic heart valve system 251, and another pair of magnetic heart valves 213 and 214 form the lower magnetic heart valve system 252. Here, the terms upper and lower are used based on the electromagnet 230, but depending on the arrangement, the terms upper and lower may be interchanged oppositely.

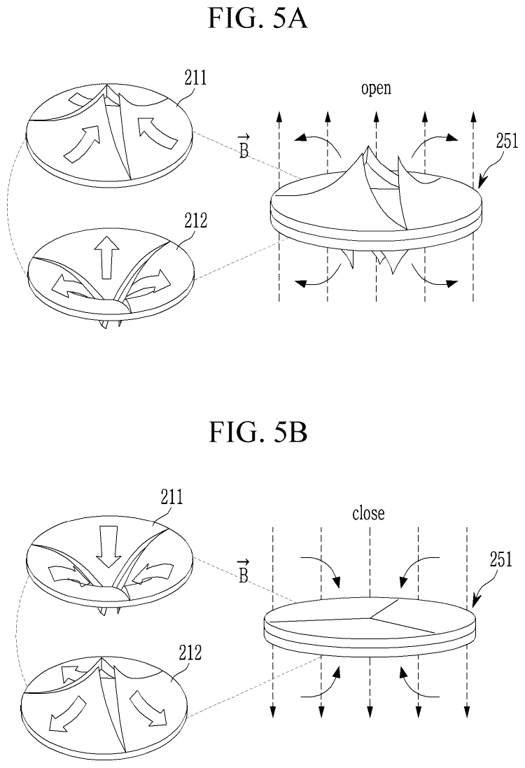

FIG. 5A and FIG. 5B are drawings explaining an operation principle of a magnetic heart valve system according to an embodiment. Here, since the operations of the upper magnetic heart valve system 251 and the lower magnetic heart valve system 252 are the same, for better understanding and ease of description, only the upper magnetic heart valve system 251 will be described in detail.

Referring to FIG. 5A and FIG. 5B, the two magnetic heart valves 211 and 212 forming the upper magnetic heart valve system 251 must have magnetization directions opposite to each other. For example, the magnetic heart valve 211 located above in the upper magnetic heart valve system 251 is magnetized in a direction toward the center, and the magnetic heart valve 212 located below in the upper magnetic heart valve system 251 is magnetized in a direction away from the center. In this way, since the two magnetic heart valves 211 and 212 forming the upper magnetic heart valve system 251 have magnetization directions opposite to each other, as shown in FIG. 5A, although the upper magnetic heart valve 211 is opened upward by the vertically upward external magnetic field, specifically, the vertically upward magnetic field generated by an electromagnet 130, at the same time, the lower magnetic heart valve 212 is opened downward, so that, as a result, the upper magnetic heart valve system 251 is opened.

To the contrary, as shown in FIG. 5B, by the vertically downward external magnetic field, specifically, the vertically downward magnetic field generated by the electromagnet 130, the upper magnetic heart valve 211 and the lower magnetic heart valve 211 are all operated in the direction to be closed, so that, as a result, the upper magnetic heart valve system 251 is closed.

In the same way, the two magnetic heart valves 213 and 214 forming the lower magnetic heart valve system 252 also need to have magnetization directions opposite to each other, which may be easily understood when referring to the description of the upper magnetic heart valve system 251 described above, and the detailed description thereof is not included herein.

On the other hand, the two magnetic heart valves 211 and 212 forming the upper magnetic heart valve system 251 may be joined to each other by using the two polyimide tapes 221 and 222 between them. At this time, the two magnetic heart valves 211 and 212 and the two polyimide tapes 221 and 222 need to be joined through a side surface in a circumferential direction, so that each of the three flaps 111 of the two magnetic heart valves 211 and 212 may be freely operated. Here, throughout this specification, the term “join” may be interchangeably with “attach”.

The two magnetic heart valves 213 and 214 forming the lower magnetic heart valve system 252 and the junction therebetween using the two polyimide tapes 223 and 224 therebetween may also be easily understood when referring to the description of the upper magnetic heart valve system 251 described above, and the detailed description thereof is not included herein.

In addition, the upper magnetic heart valve system 251 and the lower magnetic heart valve system 252 are attached to an upper end and lower end of the electromagnet 230, respectively, by using a chemical adhesive.

The electromagnet 230 may be manufactured in a small scale, so as to control the magnetic field applied to the upper magnetic heart valve system 251 and the lower magnetic heart valve system 252, and to preserve the structure of each magnetic heart valve systems 251 and 252. For example, the electromagnet 230 may be configured as a carbon steel core (material: S20C, Bugil Machinery, Korean) of a bobbin shape, manufactured by a computer numerical control (CNC), surrounded by a copper wire (diameter: 0.5 mm) of 105 turns.

The PLA housing 240 is attached to side surfaces of the electromagnet 230, the upper magnetic heart valve system 251, and the lower magnetic heart valve system 252 in the form of surrounding the electromagnet 230, the upper magnetic heart valve system 251, and the lower magnetic heart valve system 252 in order to increase structural stability of the soft magnetically regulated heart valve apparatus 200.

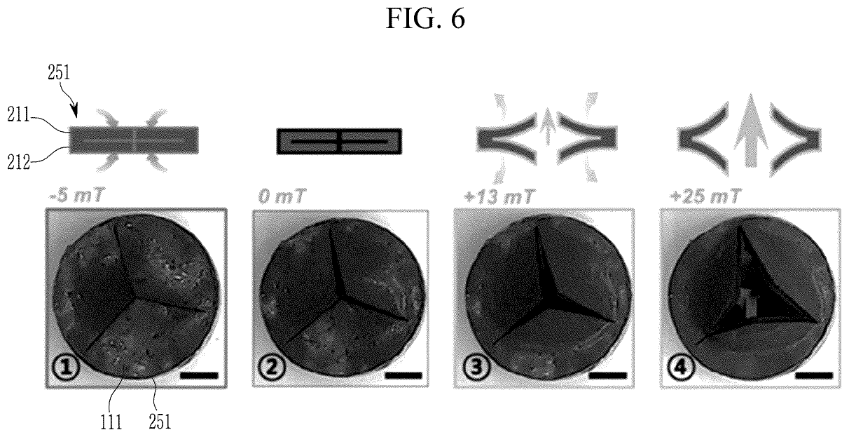

FIG. 6 is a drawing illustrating an operation example of a magnetic heart valve system according to an embodiment. Here, since operations of the upper magnetic heart valve system 251 and the lower magnetic heart valve system 252 are the same, for better understanding and ease of description, the upper magnetic heart valve system 251 will described as an example.

Referring to FIG. 6, the two magnetic heart valves 211 and 212 of the upper magnetic heart valve system 251 are joined to each other through the two polyimide tapes 221 and 222, as described above.

In such a state, when the upper magnetic heart valve system 251 is exposed to the external magnetic field, that is, a magnetic field in the range of −25 mT to +25 mT by the electromagnet 230, the upper magnetic heart valve system 251 experiences structural deformation causing closing and opening, respectively.

In more detail, within a range of −25 mT to +25 mT, the external magnetic field may be specified as four magnetic fields of −5 mT (corresponding to \textcircled{1}) , 0 mT (corresponding to \textcircled{2}) , +13 mT (corresponding to \textcircled{3}) , +25 mT (corresponding to \textcircled{4}).

First, in the case of −5 mT (corresponding to \textcircled{1}) , the upper magnetic heart valve system 251 is completely closed, and accordingly, the outflowing flow rate through the upper magnetic heart valve system 251 becomes 0.

Subsequently, in the case of 0 mT (corresponding to \textcircled{2}) , since this is the case where the external magnetic field is not applied, due to the repulsive force between the two magnetic heart valves 211 and 212 magnetized in directions opposite to each other, the upper magnetic heart valve system 251 becomes an incompletely closed state, so that the outflowing flow rate through the upper magnetic heart valve system 251 may exist in a small quantity.

Subsequently, in the case of +13 mT (corresponding to \textcircled{3}) , the two magnetic heart valves 211 and 212 magnetized in directions opposite to each other are partially opened in different directions, so that, as a result, the upper magnetic heart valve system 251 becomes an open state and the outflowing flow rate through the upper magnetic heart valve system 251 increases.

Finally, in the case of +25 mT (corresponding to \textcircled{4}) , the two magnetic heart valves 211 and 212 magnetized in directions opposite to each other are opened wide in different directions, so that, as a result, the upper magnetic heart valve system 251 becomes the open state significantly or maximally, and the outflowing flow rate through the upper magnetic heart valve system 251 becomes largest.

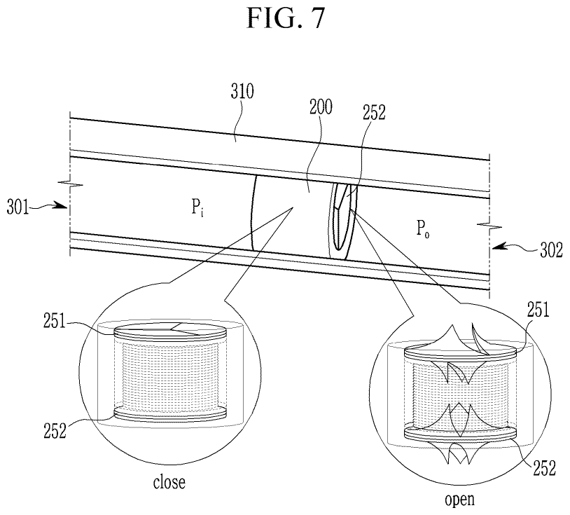

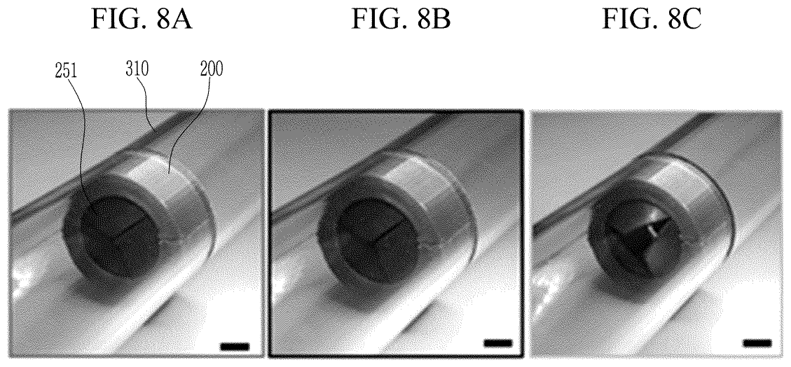

FIG. 7 is a drawing illustrating an operation example of a soft magnetically regulated heart valve apparatus according to an embodiment. FIG. 8A, FIG. 8B and FIG. 8C are drawings illustrating an actual operation example of a soft magnetically regulated heart valve apparatus according to an embodiment.

Referring to FIG. 7, FIG. 8A, FIG. 8B and FIG. 8C, the soft magnetically regulated heart valve apparatus 200 according to an embodiment is installed inside an artificial vessel 310. Here, the artificial vessel 310 has, for example, a diameter input/output (I/O) of 26/30 mm, and is made of polycarbonate.

The fluid, for example, blood in the artificial vessel 310 may be put into through an inlet 301 and flow out through an outlet 302, and at this time, the outflow amount of the fluid may be adjusted according to a shutoff operation of the soft magnetically regulated heart valve apparatus 200.

In more detail, referring to FIG. 6, as described above, the magnetic field generated by the electromagnet 230 of the soft magnetically regulated heart valve apparatus 200,, for example, −5 mT, the upper magnetic heart valve system 251 and a lower magnetic heart valve system 251 within the soft magnetically regulated heart valve apparatus 200 is closed, so that as a result, when the soft magnetically regulated heart valve apparatus 200 comes into the closed state, the fluid put into through the inlet 301 of the artificial vessel 310 cannot pass through the soft magnetically regulated heart valve apparatus 200 so that no fluid flows out through the outlet 302. This operation-state can be seen in FIG. 8A, and it may be seen that the soft magnetically regulated heart valve apparatus 200 is actually closed.

Thereafter, referring to FIG. 6, as described above, the magnetic field generated by the electromagnet 230 of the soft magnetically regulated heart valve apparatus 200, for example, +25 mT, the upper magnetic heart valve system 251 and the lower magnetic heart valve system 251 within the soft magnetically regulated heart valve apparatus 200 is opened, so that as a result, when the soft magnetically regulated heart valve apparatus 200 comes into the open state, the fluid put into through the inlet 301 of the artificial vessel 310 may pass through the soft magnetically regulated heart valve apparatus 200, to flow out through the outlet 302. This operation-state can be seen in FIG. 8C, and it may be seen that the soft magnetically regulated heart valve apparatus 200 is actually opened wide.

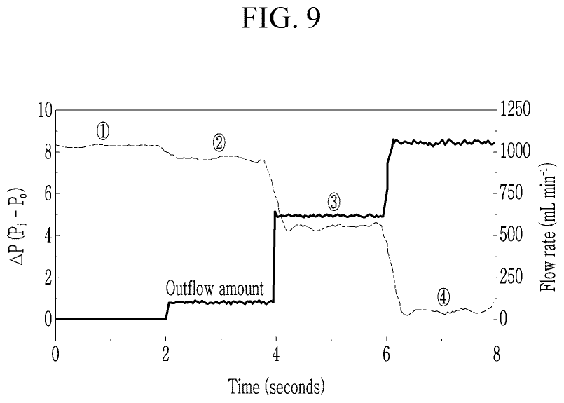

Of course, referring to FIG. 6, as described above, the magnetic field generated by the electromagnet 230 may not directly increase, for example, from −5 mT to +25 mT, but as shown in FIG. 9, sequentially or gradually increase according to time, so that, as a result, the amount of fluid passing through the soft magnetically regulated heart valve apparatus 200 may also be controlled to sequentially or gradually increase. For example, as can be seen in 8B, when the magnetic field generated by the electromagnet 230 is, for example, 0 mT, it may be seen that the soft magnetically regulated heart valve apparatus 200 is not completely closed actually, but slightly opened, and accordingly, the fluid passing through the soft magnetically regulated heart valve apparatus 200 exists although in small amount.

On the other hand, referring to FIG. 8A, FIG. 8B and FIG. 8C, it may be seen that the difference between an inlet pressure Pi and outlet pressure P0 of the soft magnetically regulated heart valve apparatus 200, that is, ΔP=(Pᵢ−Pₒ)) appears to be opposite to the outflow amount through the soft magnetically regulated heart valve apparatus 200 described above.

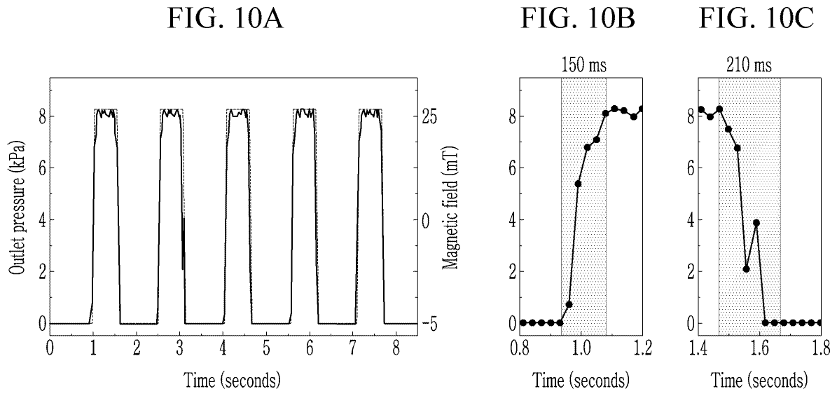

In addition, FIG. 10A represents the temporal response of the soft magnetically regulated heart valve apparatus 200, that is, the change of an outlet pressure Pₒ when the magnetic field changes from −5 mT to 25 mT, and specifically, it may be seen that the soft magnetically regulated heart valve apparatus 200 alternates, in the manner in which the outlet pressure Pₒ increases from 0 to 8.2 kPa within 150 ms (see FIG. 10B), and the outlet pressure Pₒ decreases from 8.2 kPa to 0 within 210 ms (see FIG. 10C). This result shows that there is a significant improvement of the switching seed when compared to the artificial heart valve of the conventional technology.

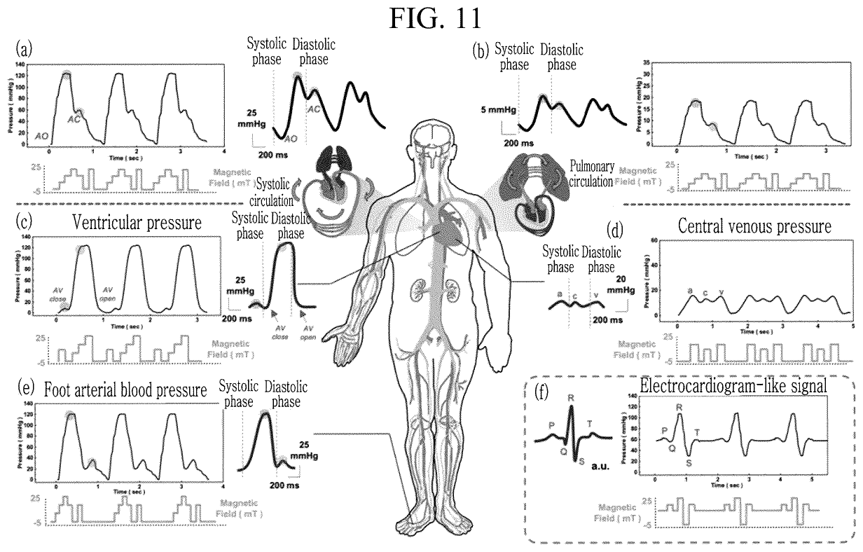

The above-described the soft magnetically regulated heart valve apparatus 200 according to an embodiment can simulate the physiology of blood pressure in the human body system as illustrated in FIG. 11.

Referring to FIG. 11, a programmed adjustment of the magnetic field using the electromagnet 230 can simulate the human body blood pulse waveforms of (a) systemic circulation and (b) pulmonary circulation that perfectly matches systolic and diastolic steps of heart (adjusted to the pressure standard of an average adult male).

In addition, by utilizing the programmable magnetic field using the electromagnet 230, various types of pulse waveforms including (c) ventricular, (d) central venous, and (e) foot arterial blood pressures can be simulated, and in addition, the waveform such as (f) electrocardiogram can be simulated.

The above-described exemplary embodiments of the present disclosure can be realized not only through a method and an apparatus, but also through a program that can perform functions corresponding to configurations of the exemplary embodiments of the present disclosure or a recording medium storing the program, and this can be easily realized by a person skilled in the art.

While this disclosure has been described in connection with what is presently considered to be practical embodiments, it is to be understood that the disclosure is not limited to the disclosed embodiments, but, on the contrary, is intended to cover various modifications and equivalent dispositions included within the spirit and scope of the appended claims.

What is claimed is:

1. A magnetic heart valve, comprising:
magnetic particles; and
an elastic silicone composite material,
wherein the magnetic heart valve has a circular plate shape, at least one heart valve shape is formed within the circular plate shape, and the at least one heart valve shape is apart from each other to allow the circular plate shape to freely bend upward or downward.

2. The magnetic heart valve of claim 1, wherein the at least one heart valve shape comprises three flaps forming a Y shape based on a center of the circular plate shape.

3. The magnetic heart valve of claim 1, wherein:
the magnetic particles are neodymium-iron-boron (NdFeB) micro particles; and
the elastic silicone composite material is Ecoflex.

4. The magnetic heart valve of claim 1, wherein:
the three flaps can be magnetized in a direction toward a center of the magnetic heart valve or magnetized in a direction away from the center of the magnetic heart valve.

5. The magnetic heart valve of claim 4, wherein, when the three flaps are magnetized in the direction toward the center of the magnetic heart valve, an operation of bending in a direction of an external magnetic field applied perpendicularly to the magnetic heart valve is performed.

6. The magnetic heart valve of claim 4, wherein, when the three flaps are magnetized in the direction away from the center of the magnetic heart valve, an operation of bending in a direction opposite to a direction of an external magnetic field applied perpendicularly to the magnetic heart valve is performed.

7. A manufacturing method of a magnetic heart valve, the manufacturing method comprising:
generating a mixture by mixing magnetic particles and an elastic silicone composite material;
curing the mixture;
forming at least one heart valve shape with respect to the cured mixture; and
generating a final magnetic heart valve by cutting a circular plate shape from the cured mixture,
wherein the at least one heart valve shape is apart from each other so that bending upward or downward of the circular plate shape is freely achieved.

8. The manufacturing method of claim 7, wherein the at least one heart valve shape comprises three flaps forming a Y shape based on a center of the circular plate shape,
wherein the manufacturing method of the magnetic heart valve further comprises magnetizing each of the three flaps in a direction toward a center of the magnetic heart valve, and
wherein the three flaps perform an operation of bending in a direction of an external magnetic field applied perpendicularly to the magnetic heart valve.

9. The manufacturing method of claim 7, wherein the at least one heart valve shape comprises three flaps forming a Y shape based on a center of the circular plate shape,
wherein the manufacturing method of the magnetic heart valve further comprises magnetizing each of the three flaps in a direction away from a center of the magnetic heart valve, and
wherein the three flaps perform an operation of bending in a direction opposite to a direction of an external magnetic field applied perpendicularly to the magnetic heart valve.

10. A soft magnetically regulated heart valve apparatus, comprising:
an upper magnetic heart valve system formed by joining two magnetic heart valves;
a lower magnetic heart valve system formed by joining two magnetic heart valves;
an electromagnet having an upper end surface joined to the upper magnetic heart valve system, and a lower end surface joined to the lower magnetic heart valve system; and
a polylactic acid (PLA) housing joined to side surfaces of the upper magnetic heart valve system, the lower magnetic heart valve system and the electromagnet, so as to surround the upper magnetic heart valve system, the lower magnetic heart valve system and the electromagnet,
wherein the magnetic heart valve comprises magnetic particles, and an elastic silicone composite material, the magnetic heart valve has a circular plate shape, at least one heart valve shape is formed within the circular plate shape, and the at least one heart valve shape is apart from each other to allow the circular plate shape to freely bend upward or downward.

11. The soft magnetically regulated heart valve apparatus of claim 10, wherein:
the two magnetic heart valves of the upper magnetic heart valve system are joined to each other by using two first polyimide tapes inserted therebetween; and
the two magnetic heart valves of the lower magnetic heart valve system are joined to each other by using two second polyimide tapes inserted therebetween.

12. The soft magnetically regulated heart valve apparatus of claim 11, wherein each of the two first polyimide tapes and the two second polyimide tapes has a second circular plate shape that is the same as the magnetic heart valve, the at least one heart valve shape forming a Y shape based on a center of the second circular plate shape is formed within the second circular plate shape, and the at least one heart valve shape is apart from each other to allow the second circular plate shape to freely bend upward or downward.

13. The soft magnetically regulated heart valve apparatus of claim 11, wherein:
the at least one heart valve shape comprises three flaps forming a Y shape based on a center of the circular plate shape;
the three flaps of two magnetic heart valves each of the upper magnetic heart valve system are magnetized in directions opposite to each other; and
the three flaps of two magnetic heart valves each of the lower magnetic heart valve system are magnetized in directions opposite to each other.

14. The soft magnetically regulated heart valve apparatus of claim 10, wherein the electromagnet provides an external magnetic field configured to control flow of fluid through the upper magnetic heart valve system and the lower magnetic heart valve system by operating at least one heart valve shape of the upper magnetic heart valve system and the lower magnetic heart valve system.

15. The soft magnetically regulated heart valve apparatus of claim 10, wherein the electromagnet sequentially or gradually changes an external magnetic field so that the upper magnetic heart valve system and the lower magnetic heart valve system may sequentially or gradually operate from a closed state to an open state.

16. The soft magnetically regulated heart valve apparatus of claim 13, wherein the electromagnet applies the magnetic field is applied in a direction perpendicular to each of the upper magnetic heart valve system and the lower magnetic heart valve system in order to adjust closing and opening of at least one heart valve shape of each of the upper magnetic heart valve system and the lower magnetic heart valve system.
